(19) United States
(12) Patent Application Publication
(10) Pub. No.: US 2011/0250795 A1
(43) Pub. Date: Oct. 13, 2011

(54) CABLE ASSEMBLY WITH IMPROVED TERMINATING MEANS

(75) Inventors: PING-SHENG SU, New Taipei (TW); XIAO-LI LI, Kunshan (CN)

(73) Assignee: HON HAI PRECISION INDUSTRY CO., LTD., New Taipei (TW)

(21) Appl. No.: 13/081,475

(22) Filed: Apr. 6, 2011

(30) Foreign Application Priority Data
Apr. 7, 2010 (CN) 201020151796.8

(51) Int. Cl. H01R 24/00

(52) U.S. Cl. 439/660

(57) ABSTRACT

A cable assembly (1000) includes an insulative housing (11); at least one contact module (13) mounted to the insulative housing, the contact module including a plurality of contacts combined with an insulator thereof, said contacts (1312) having mating portions (1315) disposed in front of the insulator and tail portions (1316) disposed behind the insulator; a cable (14) having an insulative jacket (141) and a plurality of wires (142) enclosed by the insulative jacket; and wherein the tail portions of the contacts are respectively penetrated into the wires along an axially direction.

### BACKGROUND OF THE INVENTION

1. Field of the Invention

The present invention relates to a cable assembly, especially to a cable assembly with improved terminating means.

2. Description of Related Art

A cable assembly generally refers to a cable connected to a connector. The connector includes an insulative housing, a plurality of contacts mounted to the insulative housing and a cable having a number of wires with inner conductors respectively soldered to the contacts.

However, there are some problems of terminating the wires to the contacts by soldering process. First, the cable should be trimmed, i.e. a front part of a jacket of the cable should be removed away to expose the wires, and then an insulator outside of the corresponding wire should be stripped off so as to expose the inner conductors outside, and then the wires also should be organized as they are always in a mess state. It takes much time to terminate the wires to the contacts by soldering process. In addition, the soldering process may cause environment pollution.

Hence, an improved means for terminating the wires to the contacts is required to overcome the problems of the prior art.

### SUMMARY OF THE INVENTION

An object of the present invention is to provide an improved terminating means for a cable assembly.

Accordingly, to achieve above-mentioned object, a cable assembly comprises an insulative housing; at least one contact module mounted to the insulative housing, the contact module including a plurality of contacts combined with an insulator thereof, said contacts having mating portions disposed in front of the insulator and tail portions disposed behind the insulator; a cable having an insulative jacket and a plurality of wires enclosed by the insulative jacket; and wherein the tail portions of the contacts are respectively penetrated into the wires along an axially direction.

The detailed features of the present invention will be apparent in the detailed description with appropriate reference to the accompanying drawings.

### BRIEF DESCRIPTION OF THE DRAWINGS

FIG. 1 is a perspective assembled view of a cable assembly in accordance with the present invention;

FIG. 2 is an exploded, perspective view of the cable assembly in FIG. 1;

FIG. 3 is similar to FIG. 2, but viewed from other aspect;

FIG. 4 is a partial assembled perspective view of the cable assembly, and

FIG. 5 is a cross-section view of the FIG. 1 taken along a line 5-5.

### DETAILED DESCRIPTION OF THE INVENTION

Reference will now be made in detail to the preferred embodiment of the present invention.

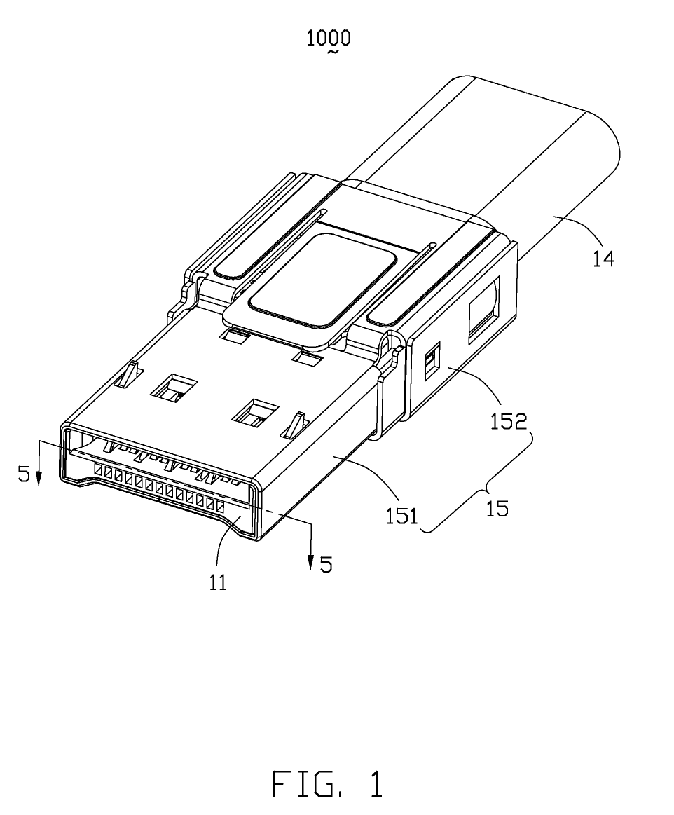

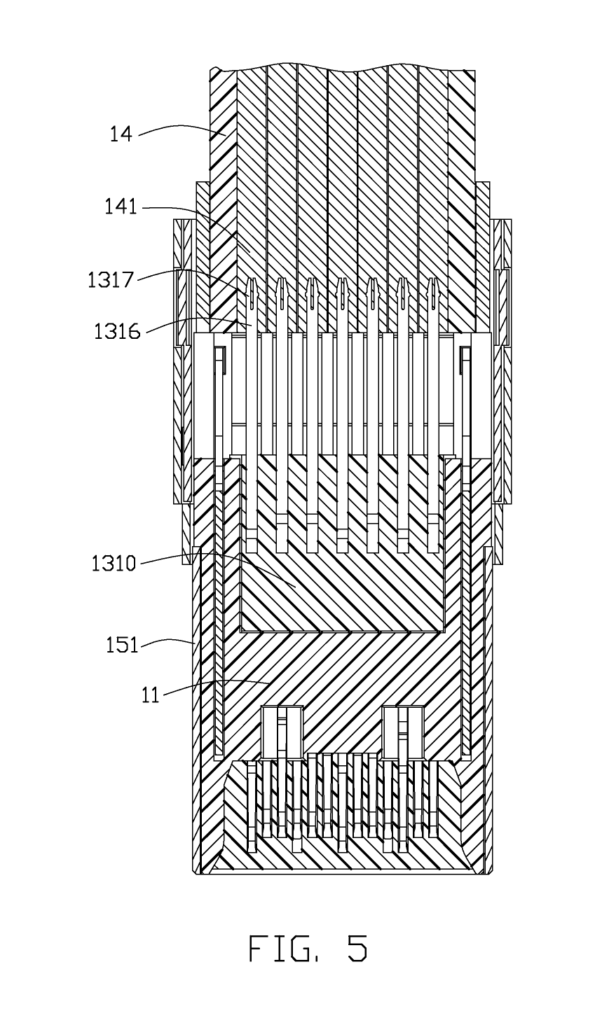

Referring to FIGS. 1-5, a cable assembly 1000 in accordance with the present invention comprises an insulative housing 11, a latching member 12, two contact modules 13, a cable 14 and a metallic shell 15.

The insulative housing 11 has a base portion 111 and two mounting arms 112 extending rearwardly from the base portion 111. There is a cavity 1111 located in a top side of a front segment of the base portion 111, and also a depression 1112 located in a bottom side of the base portion 111. In addition, there is a hollow 1113 recessed forwardly from a back edge of the base portion 111, and the hollow 1113 further communicates with the cavity 1111. A longitudinal slot 1121 is defined in an upper side of each mounting arm 112. A mounting groove 1122 is defined in an inner side of each mounting arm 112. A positioning hole 1123 is located in an end of each mounting arm 112.

The latching member 12 includes two latching arms 121 spaced apart from each other along a transversal direction and a transversal arm 122 connecting with the two latching arms 121. Each latching arm 121 extends along a longitudinal direction and has a downward retention portion 1211 at an end thereof. There are two spring fingers 1221 protrude downwardly from the transversal arm 122. The latching member 12 is assembled to insulative housing 11, with each latching arm 121 accommodated in the corresponding longitudinal slot 1121, the downward retention portion 1211 inserted into the corresponding positioning hole 1123.

The contact modules 13 includes a first contact module 131 and a second contact module 132. The first contact module 131 has a plurality of first contacts 1312 arranged in a row along the transversal direction and combined with a first insulator 1310. The first contacts 1312 has first mating portions 1315 disposed in front of the first insulator 1310 and a first tail portions 1316 disposed behind the first insulator 1310. The tail portion 1316 defines a tapered end 1317. The second contact module 132 has a plurality of second contacts 1322 arranged in a row along the transversal direction and combined with a second insulator 1320. The second contacts 1322 has second mating portions 1325 disposed in front of the second insulator 1320 and a second tail portions 1326 disposed behind the second insulator 1320. The second tail portion 1326 has a sharp end.

The first contact module 131 is assembled to the second contact module 132 along up-to-down direction, with first mating portions 1315 and the second mating portions 1325 merged into one row along the transversal direction, the first tail portions 1316 and the second tail portions 1326 separated from each other along the up-to-down direction. The first contact module 131 and the second contact module 132 are together mounted to the insulative housing 11, with front parts of the first insulator 1310 and the second insulator 1320 inserted into the hollow 1113, and mating portions 1315, 1325 extending into the cavity 1111. In addition, there are a first and second flanges 1313, 1323 respectively formed at lateral sides of the second insulator 1320. The first flange 1313 and the second flange 1323 are respectively received in the mounting grooves 1122 of the mounting arms 112.

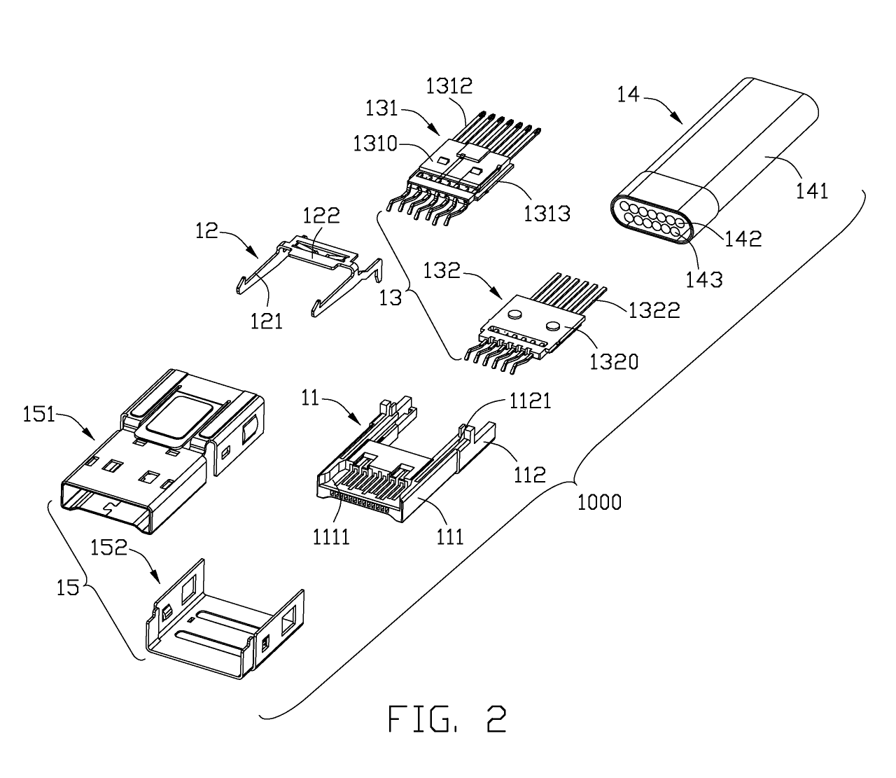

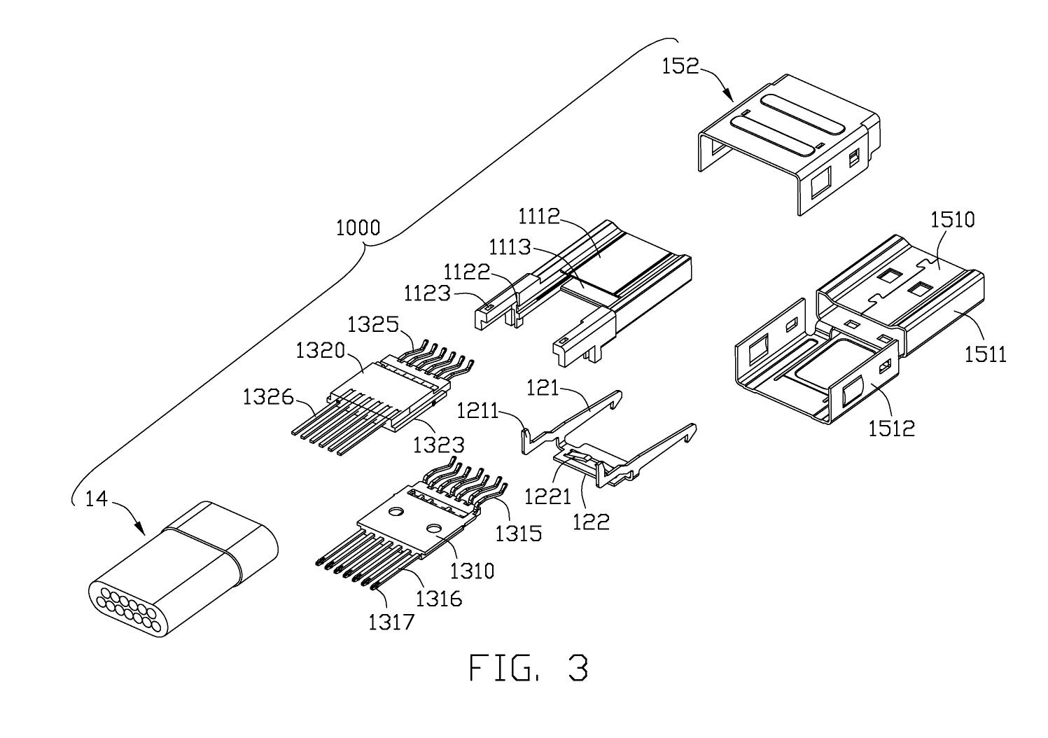

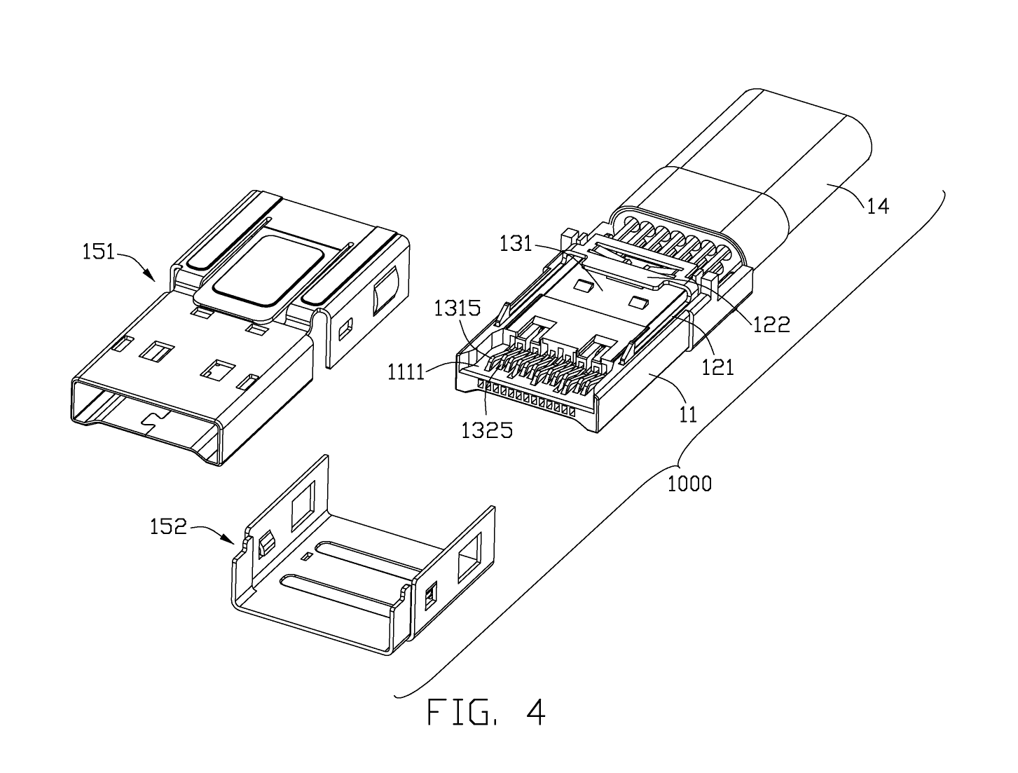

The cable assembly 1000 is compatible with DiiVA (Digital Interactive Interface for Video & Audio). Referring to FIG. 4 in conjunction with FIGS. 2-3, a distance between every two adjacent first contacts 1312 is equal to a distance between every two adjacent second contacts 1322. The mating portions 1315 of the first contacts 1312 and the mating portions 1325 of the second contacts 1312 are alternated arranged along the transversal direction. There are five grounding contacts and eight signal contacts in the first contacts 1312 and the second contacts 1322. The grounding contacts are longer than the signal contacts. Front a left to right direction, there are three differential pairs which are spaced apart from each other by the corresponding grounding contacts.

The cable 14 is flat type cable and includes a set of first wires 142, a set of second wires 143 enclosed in an insulative jacket 141. The first wires 142 and the second wires 143 are both arranged in one row along the transversal direction and spaced apart from each other along the up-to-down direction.

When assembling, the first wires 142 respectively align with the tapered ends 1317 along an axially direction thereof, and the second wires 143 respectively align with the sharp ends of the second tail portions 1326, then pushing the first contact module 131 and the second contact module 132 to have the first tail portions 1316 and the second tail portions 1326 to penetrate/insert into the first wires 142 and the second wires 143 along the axially direction. The first wires 142 and the first tail portions 1316 are combined together by micro resistance welding. The second wires 143 and the second tail portions 1326 are combined together by micro resistance welding.

The metallic shell 15 includes a first shell 151 and a second shell 152. The first shell 151 has a frame portion 1511 and an inverted U-shaped accommodating portion 1512. The frame portion 1511 has a bottom side 1510 upwardly recessed to match with the depression 1112 of the base portion 111. The second shell 152 is a U-shaped structure and can be assembled to the inverted U-shaped accommodating portion 152. The base portion 111 of the insulative housing 11 is received in the frame portion 1511. The cable 14 is sandwiched between the inverted U-shaped accommodating portion 1512 of the first shell 151 and the second shell 152.

While a preferred embodiment in accordance with the present invention has been shown and described, equivalent modifications and changes known to persons skilled in the art according to the spirit of the present invention are considered within the scope of the present invention as described in the appended claims.

What is claimed is:

1. A cable assembly, comprising:
an insulative housing;
at least one contact module mounted to the insulative housing, the contact module including a plurality of contacts combined with an insulator thereof, said contacts having mating portions disposed in front of the insulator and tail portions disposed behind the insulator;
a cable having an insulative jacket and a plurality of wires enclosed by the insulative jacket; and
wherein the tail portions of the contacts are respectively penetrated into the wires along an axially direction.

2. The cable assembly as claimed in claim 1, wherein the tail portions of the contacts and the wires are combined together by micro resistance welding.

3. The cable assembly as claimed in claim 1, wherein each of the tail portions has a tapered end.

4. The cable assembly as claimed in claim 1, wherein the wires are arranged in one row along a transversal direction, and the contacts are arranged in one row along the transversal direction.

5. The cable assembly as claimed in claim 1, wherein the insulative housing has a base portion and two mounting arms extending rearwardly from the base portion.

6. The cable assembly as claimed in claim 5, wherein there is a cavity defined in a top side of base portion, and the mating portions of the contacts extend into the cavity.

7. The cable assembly as claimed in claim 6, wherein there is a depression located in a bottom side of the base portion.

8. A cable assembly, comprising:
an insulative housing;
a first contact module and a second contact module assembled together and mounted to the insulative housing, said first contact module including a set of first contacts combined with a first insulator thereof, said second contact module including a set of second contacts combined with a second insulator thereof, said first contacts and second contacts having mating portions arranged in one row along a transversal direction, said first contacts and second contacts having tail portions respectively arranged in one row along the transversal direction and spaced apart from each other along a up-to-down direction;
a cable having an insulative jacket and a plurality of wires arranged in two rows and enclosed by the insulative jacket; and
the tail portions of the first and second contacts respectively penetrated into the wires along an axially direction thereof.

9. The cable assembly as claimed in claim 8, wherein the tail portions and the wires are combined together by micro resistance welding.

10. The cable assembly as claimed in claim 8, wherein the insulative housing has a base portion defining a cavity in a top side of a front segment thereof, and the mating portions of the first contacts and second contacts accommodated in the cavity.

11. The cable assembly as claimed in claim 10, wherein there is a hollow recessed forwardly from a back edge of the base portion and communicates with the cavity, and the first insulator and the second insulator are inserted into the hollow.

12. The cable assembly as claimed in claim 10, wherein there are two mounting arms extending rearwardly from the base portion, and there is a latch member supported by the two mounting arms.

13. The cable assembly as claimed in claim 12, wherein the latching member has two latching arms spaced apart from each other, and the two mounting arms respectively defines a longitudinal slot to receive the corresponding latching arm.

14. The cable assembly as claimed in claim 13, wherein the latching member has a transversal arm connecting with the two latching arms.

15. The cable assembly as claimed in claim 13, wherein each latching arm extends along a longitudinal direction and has a downward retention portion formed at an end thereof, and each mounting arm defines a positioning hole located in an end thereof to receive the downward retention portion.

16. A cable assembly comprising:
an insulative housing defining a module receiving cavity;
a pair of terminal modules stacked upon each other and commonly received in the module receiving cavity, each of said terminal modules including a plurality of terminals enclosed in an insulator, each of the terminals defining a main body embedded in the insulator, a planar tail section exposed behind the insulator and essentially coplanar with the main body, and a curved contacting section exposed in front of the insulator while being offset from the main body toward the other module under condition that the tail sections of the two terminal modules are arranged in two rows in a staggered manner while the contacting sections of the terminals are arranged in one row; and
a plurality of wires defining front coupling sections arranged in two rows in the staggered manner with a pitch between every adjacent two wires similar to that of the tail sections; wherein
the tail sections of the terminals respectively pierce into the corresponding wires axially.

17. The cable assembly as claimed in claim 16, wherein the cable include an outer insulative jacket to integrally enclose and hold said wires in two rows, and the tail sections of the terminals extend beyond a front edge of the jacket into the corresponding wires, respectively.
